(19) United States
(12) Patent Application Publication
(10) Pub. No.: US 2025/0048304 A1
(43) Pub. Date: Feb. 6, 2025

(54) TELECOMMUNICATIONS APPARATUS AND METHODS

(71) Applicant: Sony Group Corporation, Tokyo (JP)

(72) Inventors: Vivek SHARMA, Basingstoke (GB); Yuxin WEI, Basingstoke (GB); Yassin Aden AWAD, Basingstoke (GB); Hideji WAKABAYASHI, Basingstoke (GB)

(73) Assignee: Sony Group Corporation, Tokyo (JP)

(21) Appl. No.: 18/716,765

(22) PCT Filed: Nov. 23, 2022
(86) PCT No.: PCT/EP2022/083052

§ 371 Date: Jun. 5, 2024

(30) Foreign Application Priority Data
Dec. 6, 2021 (EP) 21212623.9

(51) Int. Cl. H04W 60/04; H04W 36/32

(52) U.S. Cl. CPC H04W 60/04; H04W 36/322; H04W 36/324

(57) ABSTRACT

A method of operating a system in a telecommunications network, the telecommunications network comprising at least a first radio node and a terminal wherein the first radio node is configured to provide a wireless access interface to communicate with the terminal. The method comprises determining that the first radio node has a movable position; determining a first indicator for the first radio node and for assisting a terminal mobility procedure, based on the determination that the first radio node has a movable position; identifying the first indicator to the radio node; receiving a registration request from the terminal; and communicating a response to the registration request to the terminal, wherein the response to the terminal identifies the first indicator as being allowed for the terminal.

### BACKGROUND

### Field

The present disclosure relates to communications devices, infrastructure equipment and methods for the transmission of data by a communications device and an infrastructure equipment in a wireless communications network.

The present application claims the Paris Convention priority from European patent application number EP21212623.9 filed on Jun. 12, 2021, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communications devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

As is well understood, various wireless telecommunications networks, such as LTE-based networks and NR-based networks, support different Radio Resource Control (RRC) modes for terminal devices, typically including: (i) RRC idle mode (RRC_IDLE); and (ii) RRC connected mode (RRC_CONNECTED). When a terminal device transmits data, RRC connected mode is generally used. The RRC idle mode, on the other hand, is for terminal devices which are registered to the network (EMM-REGISTERED), but not currently in active communication (ECM-IDLE).

In order for a core network to maintain knowledge of the location of terminal devices in idle mode, the wireless networks referred to above generally utilise tracking areas or registration areas defined by operators in order to track terminal devices to a particular geographical region consisting of a number of cells. A terminal device may roam within this tracking/registration area without transmitting update messages to the core network and as such the core network may be aware of the tracking area or registration area in which a terminal device in idle mode is located.

However, tracking areas and registration areas generally cover a large geographical area and therefore do not provide the core network with a precise indication of the location of an idle mode terminal device. Without more precise knowledge of an idle mode terminal device's location, it can be difficult or even impossible to implement certain network features. Furthermore, tracking and registration areas are generally defined when the wireless telecommunications networks are deployed and as such it is an extensive and difficult job for network operators to adjust tracking and registration areas in existing networks.

The present inventors have identified new techniques for addressing some of these challenges with wireless communications networks.

### SUMMARY

Aspects of the invention are defined in the appended claims, where due account shall be taken of any element which is equivalent to an element specified in the claims.

According to a first aspect, there is provided a method of operating a system in a telecommunications network, the telecommunications network comprising at least a first radio node and a terminal wherein the first radio node is configured to provide a wireless access interface to communicate with the terminal. The method comprises determining that the first radio node has a movable position; determining a first indicator for the first radio node and for assisting a terminal mobility procedure, based on the determination that the first radio node has a movable position; identifying the first indicator to the radio node; receiving a registration request from the terminal; and communicating a response to the registration request to the terminal, wherein the response to the terminal identifies the first indicator as being allowed for the terminal.

According to a second aspect, there is provided a core network system for use in a telecommunications network, the telecommunications network comprising at least a first radio node and a terminal wherein the first radio node is configured to provide a wireless access interface to communicate with the terminal, the core network system comprising a processor and memory for storing instructions, wherein the instructions, when performed by the processor, cause the system to carry out the method(s) of the first aspect.

According to a third aspect, there is provided a method of operating a radio node in a telecommunications network, the telecommunications network comprising the radio node and a terminal wherein the radio node is configured to provide a wireless access interface to communicate with the terminal. The method comprises transmitting a first request to a core network system identifying that the radio node has a movable position; in response to the first request, receiving a notification of a first indicator for assisting a terminal mobility procedure; and transmitting the first indicator to the terminal; when the first indicator is allowed for the terminal, receiving from the terminal a request to serve the terminal via the wireless access interface, and serving the terminal via the wireless access interface.

According to a fourth aspect, there is provided a radio node for use in a telecommunications network, the telecommunications network comprising the radio node and a terminal wherein the radio node is configured to provide a wireless access interface to communicate with the terminal, the radio node comprising a processor and memory for storing instructions, wherein the instructions, when performed by the processor, cause the radio node to carry out the method(s) of the third aspect.

According to a fifth aspect, there is provided a method of operating a terminal in a telecommunications network, the telecommunications network comprising a core network system, a first radio node and the terminal wherein the first radio node is configured to provide a wireless access interface to communicate with the terminal, the method comprising: transmitting, to the core network system, registration request; receiving a registration request response identifying a first indicator for the first radio node and for assisting a terminal mobility procedure, wherein the first indicator is based on the first radio node having a movable position and wherein the response identifies the first indicator as being allowed for the terminal; receiving, from the first radio node, the first indicator; requesting, to the first radio node and based on the response identifying the first indicator as being allowed for the terminal, that the first radio node serves the terminal via the wireless access; communicating with the first radio node via the wireless access.

According to a sixth aspect, there is provided a terminal for use in a telecommunications network, the telecommunications network comprising a core network system, a first radio node and the terminal wherein the first radio node is configured to provide a wireless access interface to communicate with the terminal, the terminal comprising a processor and memory for storing instructions, wherein the instructions, when performed by the processor, cause the terminal to carry out the method(s) of the fifth aspect.

According to a fourth aspect, there is provided Circuitry for a core network system for use in a telecommunications network, the telecommunications network comprising at least a first radio node and a terminal wherein the first radio node is configured to provide a wireless access interface to communicate with the terminal, the circuitry comprising receiver circuitry, transmitter circuitry and controller circuitry configured to control the transmitter circuitry and the receiver circuitry to transmit data or receive data, wherein the controller circuitry is configured with the receiver circuitry and transmitter circuitry to: determine that the first radio node has a movable position; determine a first indicator for the first radio node and for assisting a terminal mobility procedure, based on the determination that the first radio node has a movable position; identify the first indicator to the radio node; receive a registration request from the terminal; communicate a response to the registration request to the terminal, wherein the response to the terminal identifies the first indicator as being allowed for the terminal.

According to a fourth aspect, there is provided Circuitry for a radio node for use in a telecommunications network, the telecommunications network comprising the radio node and a terminal wherein the radio node is configured to provide a wireless access interface to communicate with the terminal, the circuitry comprising receiver circuitry, transmitter circuitry and controller circuitry configured to control the transmitter circuitry and the receiver circuitry to provide the wireless interface and to communicate with a core network system of the network and to: transmit a first request to a core network system identifying that the radio node has a movable position; receive, in response to the first request, a notification of a first indicator for assisting a terminal mobility procedure; and transmit the first indicator to the terminal; when the first indicator is allowed for the terminal, receive from the terminal a request to serve the terminal via the wireless access interface, and serve the terminal via the wireless access interface.

According to a fourth aspect, there is provided a Circuitry for a terminal for use in a telecommunications network, the telecommunications network comprising a core network system, a first radio node and the terminal wherein the first radio node is configured to provide a wireless access interface to communicate with the terminal, the circuitry comprising receiver circuitry, transmitter circuitry and controller circuitry configured to control the transmitter circuitry and the receiver circuitry to communicate with the first radio node via the wireless access interface and to transmit, to the core network system, registration request; receive a registration request response identifying a first indicator for the first radio node and for assisting a terminal mobility procedure, wherein the first indicator is based on the first radio node having a movable position and wherein the response identifies the first indicator as being allowed for the terminal; receive, from the first radio node, the first indicator; request, to the first radio node and based on the response identifying the first indicator as being allowed for the terminal, that the first radio node serves the terminal via the wireless access; communicate with the first radio node via the wireless access.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured in accordance with example embodiments;

FIG. 4 is an illustration of a secondary tracking area and its relationship with a tracking area.

FIG. 5 illustrates a system including a terminal device, a base station, and a core network part according to an example of the disclosure.

FIG. 6 illustrates a system including a terminal device, a base station, and a core network part according to an example of the disclosure.

FIG. 7 shows a flow chart of a method for a base station according to an example of the disclosure.

FIG. 8 shows a flow chart of a method for a terminal device according to an example of the disclosure.

### DETAILED DESCRIPTION OF THE EMBODIMENTS

### Long Term Evolution Advanced Radio Access Technology (4G)

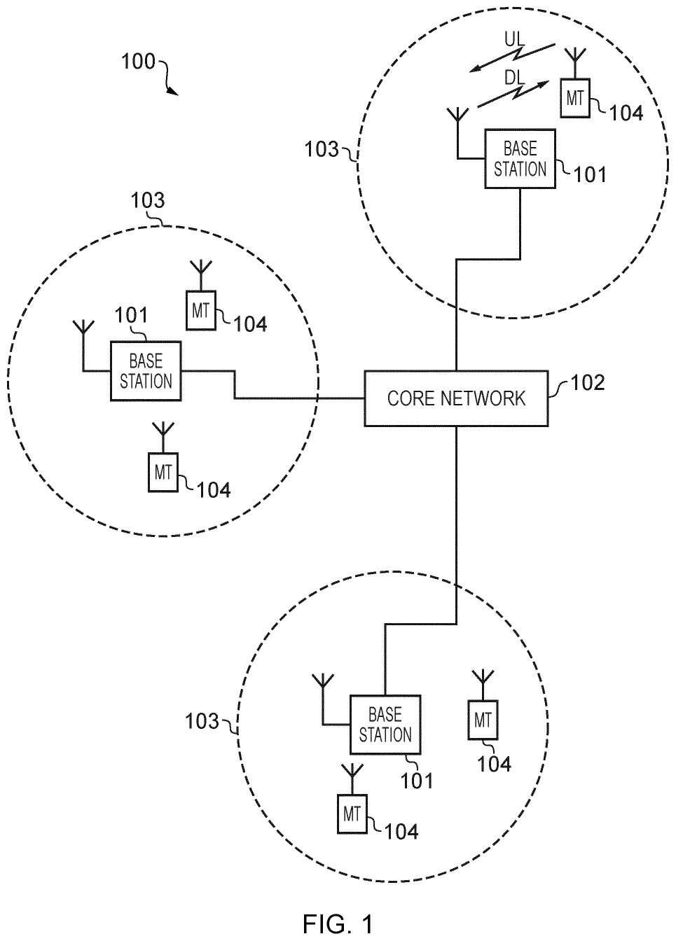

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

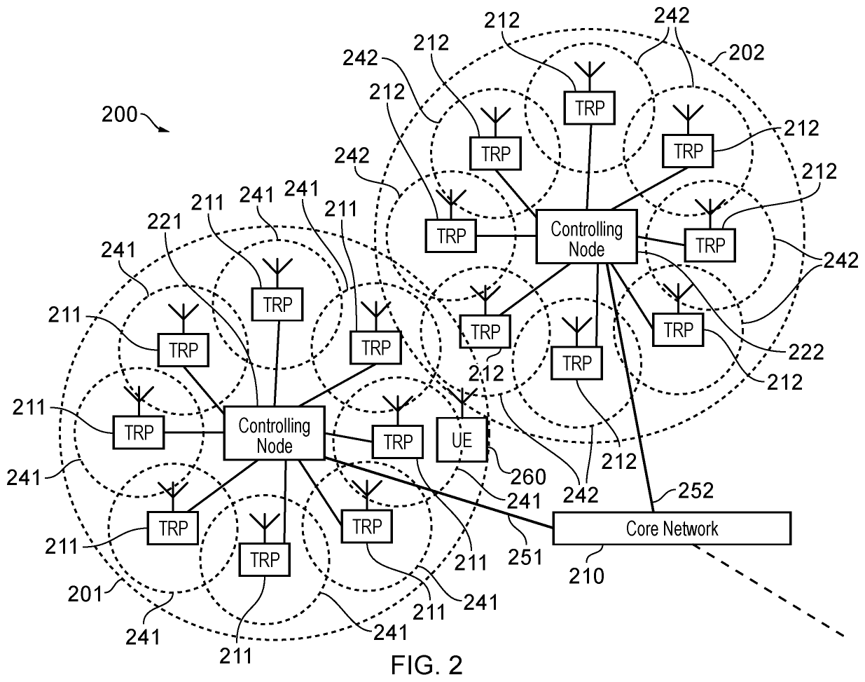

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type infrastructure equipment 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

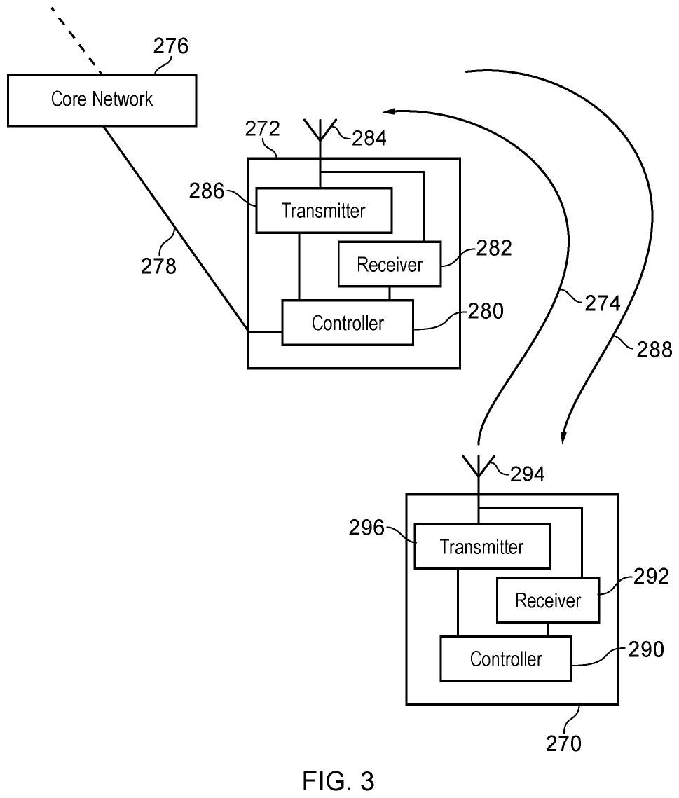

A more detailed illustration of a UE/communications device 270 (which may correspond to a communications device such as the communications device 260 of FIG. 2 or the communications device 104 of FIG. 1) and an example network infrastructure equipment 272, which may be thought of as a base station 101 or a combination of a controlling node 221 and TRP 211, is presented in FIG. 3. As shown in FIG. 3, the UE 270 is shown to transmit uplink data to the infrastructure equipment 272 via uplink resources of a wireless access interface as illustrated generally by an arrow 274 from the UE 270 to the infrastructure equipment 272. The UE 270 may similarly be configured to receive downlink data transmitted by the infrastructure equipment 272 via downlink resources as indicated by an arrow 288 from the infrastructure equipment 272 to the UE 270. As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Tracking Areas (TAs) and Additional Network Features

A Tracking Area (TA) is a collection of cells covering a particular geographical area where a UE can roam in idle mode, without being required to send update messages or other signalling to the core network. In other words, when a UE is in an idle mode (i.e. an RRC idle state), the location of the UE is known at the TA level. A UE may be configured with a specific TA (or list of TAs) which it can move between in idle mode. A TA might, for example, consist of 10 cells, where a UE roaming within these 10 cells is not required to send tracking updates to the network. In this manner, the quantity of signalling the UE is required to perform when in an idle mode is reduced.

In order for a UE to register to a TA, a base station may broadcast a TA identifier for the TA in which the base station (i.e. the cell provided by the base station) is included. The TA identifier may, for example, be included in system information broadcasted by the base station for receipt by UEs. The UE may then register with the base station and (for example, as part of the registration procedure) report the identifier of the TA to which it is connected to the core network (via the base station). In this manner, the core network is aware of the TA to which the UE is connected.

In LTE networks, when a UE moves out of a TA the UE sends a TA update message to the core network. Accordingly, the core network continues to be aware of the TA to which a UE is connected. In a similar manner, 5G networks may use a Registration Area (RA) procedure, where a Registration Area consists of one or more TAs. RA information may be exchanged between the core network and UEs during a Non-Access Stratum (NAS) registration procedure. An RA update procedure is triggered during initial registration (e.g. NAS registration) of a UE to a RA/TA, upon expiry of a timer for the UE to initiate the update procedure, and/or when the UE moves out of a TA.

For a UE in RRC idle mode, the core network is aware that the UE is present within the network, but the radio access network (RAN) part (comprising radio network infrastructure equipment such as the base stations 101 of FIG. 1 and the combined TRPs/CUs of FIG. 2) is not. The core network is aware of the location of idle mode UEs at a paging tracking area level but not at the level of individual transceiver entities, because the UE does not have a unique identifier within a cell (C-RNTI). The core network will generally assume a UE is located within the tracking area(s) associated with a transceiver entities most recently used for communicating with the UE, unless the UE has since provided a specific tracking area update (TAU) to the network. (As is conventional, idle mode UEs are typically required to send a TAU when they detect they have entered a different tracking area to allow the core network to keep track of their location.) Because the core network tracks UEs at a tracking area level, it is generally not possible for the network infrastructure to know which specific transceiver entities (radio network node) to use when seeking to initiate contact with a UE in idle mode.

Consequently, and as is well known by the person skilled in the art, when a core network is required to connect to an idle mode UE a paging procedure is used. Paging messages (i.e. signals) are transmitted to the base stations within the TA/RA in which the UE is located, where the paging messages are transmitted to all UEs within the cells of the TA/RA. UEs in an idle mode periodically monitor for such paging messages and decode received paging messages to determine if the paging message is intended for itself. For UEs operating in a discontinuous reception (DRX) mode this occurs each time they wake up for their DRX active time. Paging signals for a specific terminal device are transmitted in defined frames (Paging Frames)/sub-frames (Paging Occasions) which are derived from the International Mobile Subscriber Identifier (IMSI) of the terminal device, as well as paging related DRX parameters established in system information transmitted within the network.

In idle mode, a UE is addressed by first paging the cells within the tracking area. The UE monitors for P-RNTI (paging identifier) on PDCCH rather than C-RNTI as it does in RRC connected state. The paging message which is received following P-RNTI detection contains the UE identity, and if the UE receives this it will then respond by establishing an RRC connection and having a C-RNTI assigned.

Due to the manner in which paging messages are sent to UEs, the size (i.e. number of cells) of a TA is important. A large TA results in increased UE power consumption due to being required to decode paging messages for potentially a large number of UEs. Conversely, a small TA results in a large paging signaling load within the core network, as paging messages for various UEs are sent to a large number of TAs. However, in most cases TAs will be fixed by the core network, as these would have been established when the 5G network was deployed, and it can be a challenging and extensive task for an operator to adjust TAs, particularly after various additional features are introduced into the network.

An example of such a possible additional feature is Wireless Wirelines Convergence (WWC) which is related to for example 3GPP document TS 23.316 [2] and S2-2108855 [3] which are available on the 3GPP website. WWC allows a residential gateway (RG) to be deployed at a user's home or other premises, and for a Fixed Wireless Access (FWA) device to connect to the network via the RG. An FWA device can connect to the core network and may use the same TA and other identifiers applicable to that geographical area as mobile (non-FWA) devices. In other words, a cell and the core network may support both fixed and mobile users.

In some cases, it may be desirable to limit the access of particular devices using WWC. For example, it may be desirable for an operator to restrict the use of FWA devices outside of a home or other premises (i.e. when connected to an RG), or, for example, to allow a device to access particular (e.g. premium) services indoors only (i.e. when connected to an RG). At present it is only possible to restrict UE access at a TA level. However, in general TAs are too large in size to allow such fine grained control of the mobility of UEs to be practical. In particular, in the above situation it may be desirable to restrict the access of a UE to a geographical region consisting of approximately 2-3 cells, however TAs are generally larger than this and, as discussed above, are challenging to re-configure. As such, the present inventors have identified a desire to allow for the restriction of UE access using WWC with finer granularity than the TA level.

Another example of a possible additional network feature is Access Traffic Steering, Switching and Splitting (ATSSS). ATSSS is a means for allowing the steering, switching or splitting of traffic across multiple concurrent accesses and 3GPP documents TS 23.501 [4] and/or TS 24.193 [5] may be of interest to the reader. One particular facet of ATSSS is that a UE might be configured with a Multi-Access Protocol Data Unit (MA PDU) session over a Local Area Data Network (LADN), where the MA PDU session includes two different PDU sessions, or “legs”. A Local Area Data Network is a data network that a UE is only able to access at a particular geographic location. In the present example, one leg of the MA PDU session is over a 3GPP network, and the other leg of the MA PDU session is over a non-3GPP network, such as a Wireless Local Area Network (WLAN). In some scenarios, all traffic for an MA PDU session (e.g. all traffic for a given service) may be transmitted over the WLAN leg, and thus the UE may be in an idle mode for the 3GPP cell. In such a scenario, the (3GPP) core network is not aware that the UE is in idle mode, as when in idle mode the UE does not perform any signaling with the core network.

Particular 3GPP service requirements may require that a UE should stop exchanging data over non-3GPP access when the UE moves outside of the LADN. However, as the core network is not aware that the UE has moved outside of the LADN, the core network cannot force the UE to do so, and as such the 3GPP service requirement cannot be fulfilled. For this reason, MA PDU sessions are generally not currently permitted when a UE accesses a LADN. Accordingly, the present inventors have identified a desire to enable ATSSS support when a UE accesses services in a LADN.

### Mobile/Non-Fixed Radio Nodes

Different implementations of relays have been provided in mobile telecommunications networks and a relay can generally be defined as an equipment or element which is configured to connect wireless to a terminal and to provide a backhaul link to the network, for example to forward communications to or from the terminal. The backhaul link may be over a wired or wireless connection or any combination thereof. In many cases, the terminal will not be aware that it is connected to a relay and may thus assume that it is connected to a conventional base station (without a backhaul link). Like a base station, the relay may thus be expected to broadcast a TA and RNA for the terminals' benefit and to enable the terminal to apply conventional procedures regarding TA (or RNA) selection and updates.

In some cases, the relay may be mobile or movable, namely it may not be associated with a fixed geographical location, e.g. it may have a location which may change with time and is not stationary. There is currently no particular distinction between a fixed or stationary relay and a mobile relay and a mobile relay is therefore expected to implement the same procedures as any other relay.

Likewise, conventional base station tend to be associated with a fixed location but some base stations may in fact be movable or mobile and have a location which may change with time. As for relays, such a base station is expected to implement the same procedures as a fixed or stationary base station.

In the present disclosure, the expression “radio node” will be used in respect of a node which provides a wireless interface for one or more terminals to connect to a telecommunications network. The radio node may be a relay node (the relay being transparent to the terminal or not), a base station or any other suitable element (such as a subset of one or more components of a relay or base station). In many cases, due to the mobile or movable radio node supporting a change of its location, it is expected that it will often be connected to the next element (upstream, e.g. towards the core network) wirelessly, whether the next element is a base station, another relay (of the same or different type), a backhauling gateway or a core network element. In other words, in many cases the movable radio node is expected to be a relay node, but the teaching presented here are also applicable to a movable base station (e.g. with a wireless connection to the core network).

As mentioned above, a mobile radio node would conventionally be expected to transmit or broadcast its TA or RNA so that the terminals can apply mobility procedures. When the UE is connected to a mobile radio node and while it may remain connected to the same mobile radio node, it may also receive a number of TAs or RNAs from other radio nodes in the environment, e.g. from fixed or stationary base stations while the UE and mobile radio node are moving through the environment. In the case of the mobile radio node being a mobile relay, it may also itself detect multiple TAs and RNAs on its route.

For example, a relay may be travelling with and/or is mounted on a vehicle or a train. Passengers using this relay node may be allowed to use the radio node while others may not be allowed to access this radio node. In this case, the relay node may be served by many cells but the passenger UEs will be served mainly by the mobile relay (e.g. by the cell it provides).

Current systems are poorly designed regarding supporting mobile radio nodes and the current TA/RNAs techniques have limitations when used with mobile radio nodes. For example, while one option is that the mobile relay can have its own TA/RNA, the mobility of the radio node makes the design and allocation of the TAs or RNAs incredibly complex and increase the risk of errors. Said differently, the mobile radio node TA may then be different compared to surrounding cells or have a finer granularity of a TA. In this manner, the (core) network will be aware that the terminal is connected via a mobile radio node located (e.g. moving) within a wider TA. There are however limitations associated with such an arrangement. For example, if a train or a vehicle may travel across a country, then potentially the TA/RNA for mobile radio nodes associated with the train or vehicle have to be reserved across the country and cannot be re-used anywhere. Even if such a system may potentially be implemented, with difficulty, for a limited number of mobile radio nodes, as the number of mobile radio nodes may increase, this option is no longer practical or viable as the number of TAs/RNAs to be allocated can then exceed the number of TAs or RNAs available for use (currently of the order of 65,000 TAs are available for example).

In an alternative arrangement, a mobile relay may for example broadcast a TA/RNA of the cell it is currently connected to and do so during its journey. While this would reduce the number of TAs or RNAs used by the various radio nodes (mobile or fixed ones), the core network would not be able to differentiate between terminals connected to a fixed radio node and those connected to mobile relay. It can however be helpful for the core network to have this information available as it can help for aspects such as determining which services the terminal can access, configuring the terminal's connection (e.g. the QoS configuration), to provide accurate information to the Business support systems (BSS) of the network.

In such a case, another limitation is also associated with the terminal not being able to determine that it is connected to a mobile relay, and not to the base station associated with the TA broadcasted by the mobile relay. Conventionally, a UE does not perform any measurements of a neighbouring cell or frequency band(s) if the current radio conditions of serving cell are deemed good (see for example techniques related to s-measure). If the terminal is able to determine that it is connected to a mobile radio node, it may be desirable for the terminal to have a different configuration regarding mobility, e.g. regarding measurements and/or triggering events.

For example, the terminal may be configured not to perform measurements of other cells if connected to a mobile relay (e.g. to a car or train) in more cases or, more generally, to adjust its mobility management configuration in view of it being connected to a mobile relay. For example, the thresholds for making measurements and/or for triggering a mobility procedure may be different from the conventional configuration, e.g. they may be lowered or raised. This can be used to provide a configuration where the terminal will be less likely to make measurements of other cells and/or less likely to hand off its current mobile relay cell. In some cases, changes can includes one or more of: a threshold of a current link quality for making measurements of neighbouring cells might be lowered (e.g. if measurements are made when the link quality is below the threshold), a link quality difference or delta between the current link quality and the link quality of a neighbouring cell might be increased (e.g. if the terminal would consider handing over to the neighbouring cell if the quality of the link to the neighbouring cell is greater than then current one by an amount of at least the delta), a threshold of a link quality of a neighbouring cell may be increased (e.g. if the terminal would consider handing over to the neighbouring cell if the link quality is above the threshold), etc. Generally, the skilled person will be familiar with the different types of events that can trigger mobility decision in a terminal (or in the network) and how adjusting each parameter affects how likely the terminal will be to leave the current cell or stay in the current cell. Accordingly, the skilled person will understand how the terminal can have two configurations, a first one (e.g. a default one) and a second one (e.g. for mobile radio node) where when the second configuration is active, the terminal is less likely to leave the current cell compared to when the first configuration is active.

However, if the terminal is not able to determine that it is connected to a movable radio node, e.g. because the radio node broadcasts the TA/RNA of the cell it is connected to, then the terminal cannot make any adjustments based on being connected to a moving radio node. The configuration is therefore likely to be unsuitable for either of or both of conventional radio node connections and moving radio node connections.

It will be appreciated that the terminal can face particular challenges even when the terminal may be able to detect that it is using a mobile radio node, for example, even in cases when mobile (movable) radio nodes are allocated a special TA. For example, a terminal may then be configured to use a s-measure configuration for mobile (movable) cell which is set to a lower value than usual (e.g. than a default value which is expected to be in use e.g. with fixed radio nodes), such that UE does not perform any measurements of neighbouring cells, even further away from the centre of the cell. This may help the UE remain connected to (usually preferred) mobile relays or radio nodes. However, a lower s-measure can also sometimes result in more handover failures and reduce or even break the service continuity for the terminal. For example, if a vehicle is in a traffic jam, other mobile cells or terminals in the area may generate interferences which can render the mobile cell unsuitable.

As will be appreciated, a TA or RNA is traditionally associated with a geographical area, which is adapted to handling fixed or stationary radio nodes, such as fixed relays. Mobile relay are not widespread at this stage and are not particularly well supported with the network currently mostly reusing the main radio node/gNB procedures and techniques. As a result, when trying to adapt current systems to relays, it is expected that either (1) if a relay does a TA update, then the UE may do the same which is inefficient in terms of power and signalling overhead or (2) a fixed TA is used for the relay which is also inefficient. Current systems are not expected to scale up to each relay having its own TA and using a single TA for relays is also sub-optimal (e.g. due to the lack of granularity and issues related for example to traffic jams, where all the cars will have the same TA).

Furthermore, usually only selected UEs will be allowed to access a mobile (movable) cell. Accordingly, it might helpful to be able to identify if a cell is a mobile (movable) cell or not to control access to the cell and/or so that a connected UE can perform enhanced/adapted measurements.

It has been a key design principle in current networks that the core network is unaware of the RAN topology and configuration such that using a granularity at a cell level would violate this design principle. In other words, it would be undesirable for the core network to have to rely on the cell/RAN topology in its procedures.

In brief, current networks and network procedures are not well adapted to fixed relays but not well equipped to handle mobile relays. The challenges faced by the terminals and networks (or network elements) in an environment with radio nodes can be mobile or movable are complex and involved different components such as location granularity, access control, network managements constraints, link quality and service continuity for terminals and current techniques are not well adapted to handle movable radio nodes and it would be helpful to provide greater support for moving radio nodes in respect of one or more of these components.

While many of the examples provided herein discuss a car, train or other vehicles, it will be appreciated that the techniques discussed herein are not limited to these examples and are equally applicable to any other type of radio node that does not have a fixed location, e.g. an unmanned aerial vehicle (“UAV”), satellite, etc.

### Indicator or Secondary Tracking Area

In accordance with techniques discussed herein, there is provided an indicator for a radio node, such as a Secondary Tracking Area (STA), where the indicator is for assisting a terminal mobility procedure and is based on the determination that the first radio node has a movable position.

The use of an indicator which indicates that the radio node is a mobile or movable radio node enable on one hand the terminal and separately, on the other hand, the core network to make decision based on this information.

Additionally, providing an indicator indicating a mobile radio node enables the network to have a different level of granularity, for example compared to the granularity of the TA or RNA if such a technique is used as well. For example, the indicator may in some cases be used as a secondary tracking area, in a similar manner to the current TA or RNA techniques but with a different distribution and/or a finer granularity. In some cases, a finer granularity could mean that an STA could cover one or more cells within a TA (or across different TAs) with on average, fewer cells and/or a smaller geographical area within a cell or group of cells associated with the STA than with a TA or RNA, such as an area covered by a beam (e.g. with a gNB that supports directional beams). An STA or SRNA (referred to hereinafter as an STA for brevity) is a collection of one or more coverage areas which may be within a TA or an RNA, which can provide a different, e.g. finer, granularity than the corresponding TAs or RNAs when within a TA or RNA. In other words, an STA may comprise a subset of the cells of a TA (or more TAs) or even a portion or subdivision of one or more cells of one or more TAs or RNAs, which are assigned an STA identifier. The relative size of dimension of STAs in respect of TAs or RNAs (if provided) may therefore be selected to balance the precision of the location information associated with the STA, the level of signalling associated the STA dimensions, the type and number of mobile (movable) radio nodes in an area, the maintenance associated with (re)configuring the STAs, etc. The core network may also better control access to mobile (movable) radio nodes using the indicator thereby allowing or excluding access to one or more terminals based on the radio node not being a fixed or stationary mobile node.

With techniques of the present disclosure, while the radio node, for example a relay node, which is mobile can be better supported across the network.

In many relay configurations, the UE is unlikely to be aware if the cell it connects to is either a relay (e.g. IAB) cell or a normal cell. This is for example the case in IAB systems defined in Release 17 systems. As discussed above, it can be beneficial for at least the UE to have information regarding whether the cell is a mobile (movable) cell or a stationary cell. In one implementation, the radio node (e.g. relay) can broadcast an indicator indicating whether it is mobile (movable) or stationary. For example, this indicator may be a 1 bit indicator being set to 0 or 1 if the radio node is stationary and to 1 or 0, respectively, if the radio is mobile. Such an indicator usefully provides a simpler implementation (e.g. more limited modifications to existing systems and less complex decision making) but this is balanced with providing less rich information. For example, a one-bit indicator may be more challenging to use for a UE to select a mobile cell/radio node as access may in fact be denied. But it may still be helpful for example for the terminal to configure its measurements or more generally mobility procedure configurations. It may also be used with other features such as mobile cell being part of Standalone Non-Public Network (SNPN) and a unique Non-Public Network (NPN) ID may be assigned to each Mobile cell. While this may require the UEs and networks to support additional features (e.g. NPN features), the indicator may still be used for cell selection taking into account access control, and in any case it can be used by the terminal to configure the mobility management procedures.

In another example, the indicator is provided as an STA or likewise, as a Secondary RNA (RAN Notification Area). An RNA is a list of cells where UE is allowed to perform cell reselection without informing the RAN node and initiating a resume procedure. Currently RNA is used in RRC_Inactive state only. In one example, the indicator provided as a secondary RNA (SRNA) is configured in a manner similar to an STA and applicable to all RRC states. Accordingly, the terminal can have an indicator that may be used in RRC_inactive, RRC_Connected, any other RRC state, or any combination thereof.

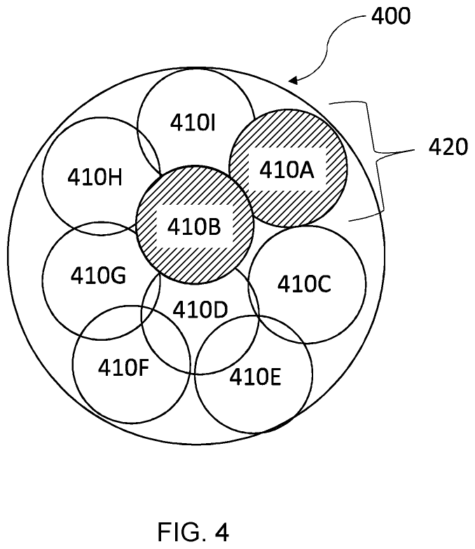

As the radio node is geographically mobile and may change position, the indicator may not always be defined in respect of an existing TA or RNA. For example, the cell of the radio node may travel across zones covered by different TAs but in other cases the cell may remain in a zone which is associated with a TA or RNA. For example, a drone relay may be mobile but remain within an area covered by a TA (or more). In the latter case, the STA or secondary RNA may be provided as a subset of a TA or RNA (or more). Such an example is illustrated in FIG. 4.

In the example TA 400 of FIG. 4, the cells 410A and 410B are part of the TA 400, which includes cells 410A-4101, however the cells 410A and 410B are also part of a secondary tracking area 420. Therefore, STA 420 includes a subset of the cells 410 included in the TA 400. In the present example, the TA 400 includes 9 cells 410, while the STA includes only 2 cells 410A, 410B, however it is appreciated that the number of cells in the TA and the number of cells of said TA included within the STA may vary, provided the number of cells included in the STA is smaller than the number of cells of the TA(s) in which the cells of the STA are also included.

In one example, the cells of an STA are a subset of cells included within a TA. A TA may include multiple STAs, and, for example, every cell within a TA may be assigned to an STA, or in some cases a particular cell may be assigned to an STA but not to a TA, or vice versa. In some examples, an STA may span multiple TAs. In other words, an STA may include a plurality of cells, where the plurality of cells are chosen from the cells of two or more TAs, where the plurality of cells of the STA include at least one cell from each of the two or more TAs, such that the STA includes cells belonging to at least two TAs. However, if an STA spans multiple TAs, the STA includes only a subset of the cells included within each of the TAs.

STAs or Secondary RNAs in general and for example the STA 420 of FIG. 4 may function in a similar manner to a TA or RNA, for example in a similar manner to the TA 400 in many respects. For example, when a UE leaves the STA 420 (or enters a new STA), the STA may be required to send an STA update message to the core network, in a similar manner to conventional TA update messages. Furthermore, a UE may be able to roam between the cells 410A, 410B of the STA 420 without having to send said STA update messages to the core network. In this way, the core network may be aware that a UE in idle mode is located within the small group of cells corresponding to the STA 420, allowing the location of the idle mode UE to be more precisely known by the core network, without the core network being aware of the RAN topology (as may be the case if the location of a UE were known on a per-cell basis).

In general, a base station providing a first cell (e.g. cell 410A, 410B) may broadcast the indicator as an identifier for the STA in which the cell is included. The STA identifier may be included in system information broadcast to UEs (such as SIB1) within the cell, where the system information may also include the TA identifier for the TA in which the cell is included, as well as other cell access related information. The STA may be broadcast using hexadecimal values where particular values (such as 0000 and FFFE) may be reserved. Upon receiving the STA identifier, a UE may connect to the cell and transmit a message to the core network indicating the STA in which the UE is connected/located. In this manner, the core network is aware of the STA in which a UE is located.

After reading the STA identifier, but before connecting to the cell, the UE may determine whether or not it is permitted to access the particular STA. The UE may do this by comparing the STA identifier with a list of STAs which the UE is permitted to access. The UE may already be configured with a list of permitted STAs, or the UE may receive the list of permitted STAs during a registration procedure (e.g. NAS Registration procedure). Therefore, if the UE, after receiving the STA identifier from the base station, is not able to cross-reference a list of permitted STAs, the UE may initiate a registration procedure (e.g. a NAS registration procedure) with the base station. To do so, the UE may transmit a registration request message to the base station and may in response receive a list of permitted STAs. The UE may receive additional information in response to the registration request, as will be discussed later.

Upon receiving the list of permitted STAs, the UE is then able to determine whether the STA identifier is present in the list of permitted STAs and therefore whether the UE is permitted to connect to the STA. If the STA is on the list of permitted STAs, the UE may camp on the cell. If, however, the STA is not on the list of permitted STAs, the UE may not camp on the cell. Instead, the UE may select another cell. The UE may do this based on any of a number of different factors, such as a frequency priority list, or an Intra Frequency Reselection Indicator (IFRI). In order to allow for cell reselection based on an IFRI, system information broadcast to UEs (for example the system information including the STA identifier) 40 may include an IFRI bit that is applicable to the STA.

If configured with an STA, a UE moving out of a particular STA may perform an STA update procedure. That is, when a UE detects that it is moving out (or has already moved out) of a cell included in particular STA and into a new cell included in a new STA, the UE performs an STA update procedure. Such a procedure may be similar in many respects to the TA update procedure, which is understood by the person skilled in the art. The STA update procedure may, for example be a NAS, Access Stratum (AS), or N2 procedure. When performing an STA update procedure, a UE may receive or determine an STA identifier associated with the new STA from the new cell, in a similar manner to that described above for initial registration of the UE to an STA. A UE may then transmit an update message to the core network (via the previous cell or the new cell), informing the core network of the new STA in which the UE is located.

In some cases, the UE may determine whether or not the UE is permitted to access the new STA, for example by comparing the new STA identifier with a list of permitted STAs. If the UE determines that the UE is permitted to access the new STA, the UE may camp on the new cell. Otherwise, if the UE determines that the UE is not permitted to access the new STA, the UE may select a new cell using the techniques described above, or may remain connected to the previous cell. In some implementations, the UE may determine that it is not required to send STA updates when moving to the new STA, for example by determining based on the new STA identifier that the new STA is within a register of STAs where tracking updates are not required to be sent by the UE. In other words, depending on the implementation a UE may be able to roam between multiple specific STAs without sending STA update messages to the core network, or in other implementations a UE may be required to transmit STA update messages to the core network when moving between any STAs.

The use of STAs as described above means that paging of UEs can be further optimized, as the paging of UEs connected through a mobile radio node may be improved compared to using a single TA for all (or a larger group) of mobile radio nodes. This is because the core network will know the location of a UE at finer granularity. In particular, paging signalling load within the core network can be reduced, as paging messages are sent to fewer base stations due to the location of a UE being known more precisely. Furthermore, in such a case, the UE power consumption is also expected to be reduced, as UEs are required to decode fewer paging messages, as there will on average be fewer UEs in an STA than across all (or a larger group) of mobile or movable cells. In addition, as a UEs location is known more accurately, particular services can be enacted in order to better meet service requirements. It may also be noted that these techniques can be implemented without implementing cell-level granularity, where the core network would be aware of the specific cell in which a UE is located, and a UE may be required to transmit update messages to the core network when moving to a new cell. Implementing such cell-level granularity would potentially lead to the core network being aware of the RAN topology, which contradicts one of the design principles of current 3GPP networks, as discussed above.

It will be appreciated that an STA could also be defined in more than two dimensions (e.g. as a cell on a 2D map), for example it could be defined in three dimensions (e.g. as a volume). A vertical dimension on a vertical scale can be identified based on UE altitude sensor or 3D beamforming direction. Having information about the height or altitude of the radio node might be beneficial, for example because it can provide an indication about the future position of the radio node. For example, an UAV flight direction could be different depending on the altitude level as defined by UAV traffic control. In one example, UAVs in high altitude go eastbound, those in low altitude go westbound. There could thus be provided in an area two or more STAs in the same geographical zone may overlap when considered in (at least) two dimension but may be associated with two different altitude ranges, e.g. one is for low altitude radio nodes, and the other for high altitude radio nodes. For example, UAVs in high altitude register with STA #1 and broadcast this secondary tracking area STA #1 while UAVs in low altitude register with STA #2 and broadcast STA #2. A UE can select a suitable radio node based on the STA being associated with a mobile node and may also select the STA associated with a level of altitude.

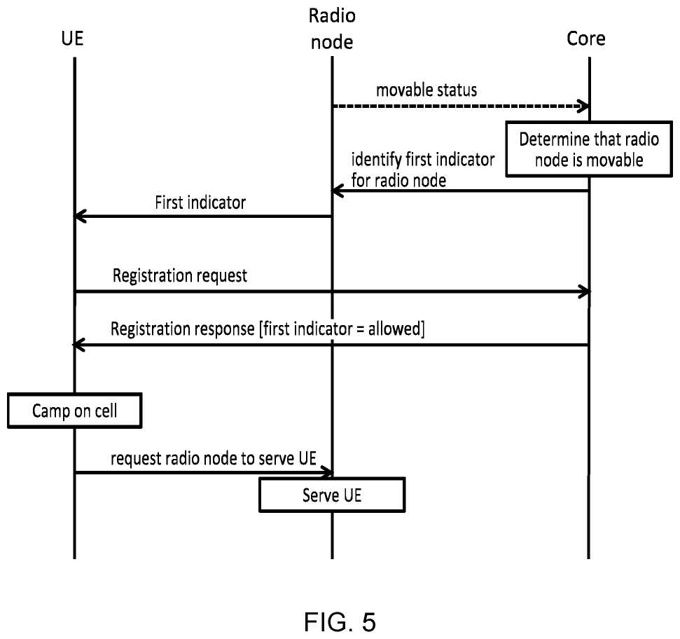

FIG. 5 illustrate an example call flow in accordance with a technique of the present disclosure. In this example, a core network system determines that a radio node is movable. The core network system may comprise any one or more elements of the core network. In many cases, it is expected that the core network system comprises at least the AMF and in some cases it may also comprise another element of the core network. In some examples, this may be provided by the radio node providing an indication that it is not stationary although in other examples, the core network may be configured with a list identifying the radio node and their associated stationary or mobile/movable status. In cases where the radio node informs the core network and where the radio node is a relay node, this information may be communicated when during one or more stages of the radio node setting up its movable cell. For example in an IAB relay system, an IAB node (a type of relay) is expected to inform the core network that it is a relay node, and this type of signalling may be used to also identify that the relay node is a mobile or movable relay node.

Upon determining that the mobile node is movable, (i.e. mobile or not stationary) the core network system will identify a first indicator to the radio node. In an example, the core network may transmit an area indicator, such as an STA and/or Secondary RNA, to the radio node. In another example, the core network system identifies to the radio node that the radio node can advertise a one-bit indicator identifying its movable status.

The radio node may then communicate the first indicator to the UE. For example, the first identifier may be included in system information broadcasted by the radio node for receipt by UEs. Depending on the configuration of the radio node, the radio node may be configured to use a one-bit indicator and/or the received indicator (whether it is indicating a one-bit indicator to transmit or broadcast, or not).

Independently (e.g. at the same time, before or at least partially in parallel), the UE sends a registration request to the core network and, in the response to the request, receives an identification that the first indicator is allowed. It can for example identify that the terminal is allowed to access a mobile radio node (e.g. when a one-bit indicator is used). Additionally or alternatively, if the indicator identifies an area (e.g. an STA or secondary RNA), the request may identify that the terminal is allowed to use radio node associated with the identified area.

In some cases, the registration request may identify that the terminal supports this identifier (e.g. STA) system and can receive one or more identifiers associated with a movable radio node. The core network may then send to the terminal both legacy information, as well as (at least) an identifier as discussed herein. This may for example be useful if trying to ensure backwards compatibility with legacy systems.

The UE may then carry out an access control based on whether the indicator received from the radio node matches what has been identified as allowable by the core network. Based on a determination that the UE has received the first indicator from the radio node, the UE can camp on the cell and, if it needs to communicate through the radio node (e.g. if it has data to send or if it is being pages), the UE can connect to the radio node to be served by the radio node. This may for example involve exchanging (e.g. RRC) messages with the radio node so that the UE can transition to a (e.g. RRC) connected mode with the radio node.

As mentioned above, the messages illustrated in FIG. 5 may be carried out in a different order. Additionally, they may also be carried out more than once. For example, the terminal may receive an identifier from the radio node, detect that it does not hold identifier mapping information. In response to this detection, it can initiate a registration procedure to obtain one or more identifiers allowed for the UE, so that the UE can map the identifier received from the radio node against the one or more identifiers received from the core network.

If the UE is configured to use such an identifier and is currently connected to a radio node identified (through its associated identifier) as being movable, the UE can be configured to perform measurements of the serving cell measurements and cells of allowed by the identifier. For example, and possibly if a certain condition is met (e.g. regarding one or more of a link quality with the current cell and a link with one or more neighbouring allowed movable cells being above a threshold), the UE may limit its measurement to this current cell and these one or more neighbouring allowed movable cells. Additionally and as discussed above, the terminal may use a different measurement and mobility triggering event configuration when connected to the movable radio node compared to a conventional radio node (e.g. not associated with an identifier identifying a movable radio node).

For example, in some cases a secondary RNA (or STA) may be defined that is associated with multiple relay node on a train and all the corresponding mobile cells can be covered under a single secondary RNA (or STA) and control mobility of UEs in this zone.

The UEs may also be configured to, when connected in a movable identifier-activated radio node, only send a location update to the core network (e.g. tracking area update) when it moves out of the zone associated with the current identifier, for example to a cell or radio node not associated with a movable identifier, or to a cell or radio node associated with a different movable identifier (e.g. from a train zone to a car zone). This may be the case whether the UE's TA or RNA remains the same (e.g. a single value associated with mobile radio nodes throughout the network), or whether the UE's TA or RNA changes (e.g. as the train travels across different region, in which case the terminal may be configured to disregard the change of TA or RNA so long as the identifier has not changed since the last location update).

Also, the terminal may be paged based on its TA/RNA and/or its current movable identifier (e.g. one-bit indicator or STA/SRNA). For example, a UE may sometimes be paged based on its STA (e.g. all UEs on a train will attempt to decode), based on a TA (e.g. in a conventional manner) or based on a combination of tracking area and identifier (e.g. all UEs in a TA and connected to a movable radio node identified with a one-bit identifier will attempt to decode the paging message).

The use of such an identifier also allows control of mobile cell deployment based on a subscription database and the core network authorizing the mobile node. This is useful for example to avoid unauthorized use of operator license frequency and to control access.

As will be appreciated, there may be cases where the indicator is (or includes) a one-bit indicator that a radio is movable or stationary and where the terminal has been notified by the core network that it can use such movable radio nodes. In such cases, the mobile cell will broadcast an indication that it is a mobile cell (e.g. in an AS indication) and the terminal can use the mobile cell as soon as it is identified as including the movable indicator.

Additionally or alternatively, a terminal may be configured with allowed (movable radio node zone) identifiers in an RRC release procedure, in an Access Stratum (AS) indication. In some cases, this may be used to configure or update the allowed identifiers for the UE. In a case where allowed identifier(s) are received from an AS indication, the UE can pass one or more received STA value or indicator (e.g. from a radio node's broadcast) to either NAS layer or to process in AS layer. In some examples, the radio node may also determine whether the new indicator in an indicator update message (when the terminal changes from a radio node associated with one indicator to a second radio node associated with another indicator) is an allowed one, using techniques similar to those used in an RNA update. In some cases, the core network may later check that an allowed indicator (e.g. STA or secondary RNA) is used, for example at the time of subsequent indicator update, e.g. when the terminal changes from a radio node associated with one indicator to a second radio node associated with another indicator. This is somewhat similar to the mechanisms involved in a TA update. For example, the UE can use NAS messaging to confirm whether access is allowed or not, for example sending a request including the relevant identifier(s) and the core network responding with information identifying whether these relevant identifiers are confirmed as being allowed.

In some cases, the UE can report the indicator or STA/SRNA to the radio node, for example in msg 5 of a new connection to the radio node, indicating it is allowed to access mobile cell. The radio node can then forward this indicator to the core network to verify against subscription information. In the case of SRNA, as discussed above, the radio node can perform the verification based on the information available in the node regarding which indicator (SRNA) is allowed for the UE.

In some cases, the UE can also or alternatively report the indicator or STA/SRNA of (at least) a neighbour cell for SON-ANR (Self-Organising Network-Automatic Neighbour Relations) only if the neighbouring cell is mobile cell. This can for example help to avoid using these cells as handover targets for UEs not registered with a mobile cell.

As discussed above, while it is expected that the techniques discussed herein are likely to be implemented mostly with radio nodes which are relay nodes, other radio nodes (e.g. movable or non-stationary base stations) may also be used with these techniques. Additionally or alternatively, the radio node may be a UAV (or drone) which operates as a relay or as a base station. It will however be appreciated that a UAV operating as a relay or base station may also be configured to operate as a terminal. It may for example be a UE that can be activated as a relay node and/or base station.

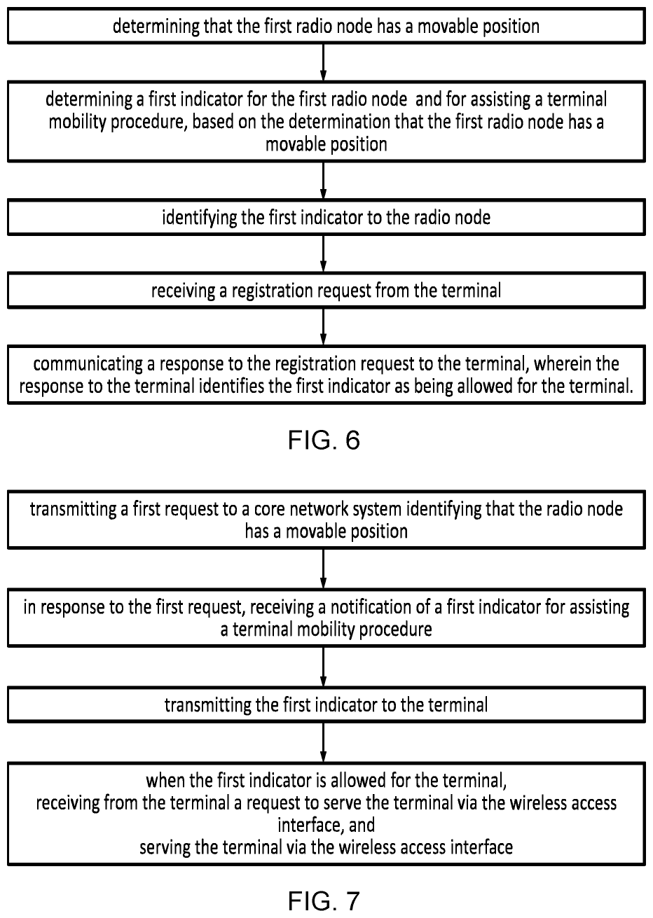

FIG. 6 illustrates an example method of operating a core network system in accordance with techniques discussed herein. The system can be used in a telecommunications network, where the telecommunications network comprises a first radio node and a terminal, the first radio node being configured to provide a wireless access interface to communicate with the terminal. The method comprises determining that the first radio node has a movable position, for example that the first radio node is not associated with a fixed location. The method comprises determining a first indicator for the first radio node and for assisting a terminal mobility procedure, based on the determination that the first radio node has a movable position. The first indicator may comprise one of or any combination of:
a secondary tracking area (a group of one or more coverage areas used in a manner similar to a TA, namely managed at the core network level, where a coverage area is one of a cell or a sub-part of a cell or another area associated with a coverage of a radio node);
a secondary RAN-based notification area (a group of one or more coverage areas used in a manner similar to a RNA, namely managed at the radio access network level, where a coverage area is one of a cell or a sub-part of a cell or another area associated with a coverage of a radio node);
an indicator identifying a radio node having a movable position; and
a one bit indicator identifying a radio node having a movable position.

It will be appreciated that in some cases, the indicator will be an indicator that is used for managing mobile (movable) radio nodes such that providing this type of indicator will implicitly identify at the same that the radio node as being movable. In other cases, an explicit identification may be provided, such as a one-bit indicator identifying whether the radio node is movable or not, instead or in addition to a further identifier. While in cases where the indicator is a secondary RNA, the RAN (e.g. radio node) is expected to identify the appropriate indicator to use for the radio node, in some cases, the radio node may inform the core network of this indicator and/or the core network may provide a one bit indicator to the radio node.

The method further comprises identifying the first indicator to the radio node. This may include transmitting the indicator to the radio node. Alternatively or additionally, it may include implicitly or explicitly signalling to the radio node (i) that the radio node is mobile and/or (ii) which indicator to use. For example, in a case where the indicator includes at least one bit for identifying whether the radio node is movable, some of the signalling between the radio node and the core network system may imply that the radio node is registered and/or allowed and/or identified as a movable radio node and on that basis the radio node may identify which of the two one-bit indicators to use in its signalling to terminals.

The core network system may then receive a registration request from the terminal and may communicate a response to the registration request to the terminal, wherein the response to the terminal identifies the first indicator as being allowed for the terminal. For example, it may provide a list of indicators that the terminal is allowed to access, where the list may be empty (e.g. if it is not allowed to access any radio node that is associated with a movable indicator) or may include one or more indicators that the terminal is allowed to access. It will be appreciated that even in cases where the terminal is not allowed to use a movable radio node, the list may not be empty. For example, in a network configures to have all radio nodes (implementing techniques discussed herein) broadcast “0” if they are fixed and “1” if they are movable, such a terminal may be configured with a list of allowed indicators of “0”. On the other hand, another terminal allowed to use both fixed and mobile/movable radio nodes may receive a list with “0” and “1”. Likewise, a list of “1” only would result in the terminal allowed to connect to movable radio nodes only.

It will be appreciated that if an indicator has different components, the list might mirror this structure. For example, a radio node may broadcast a “0” if fixed and “1” if movable and, if movable may also send a second part of the indicator, such as indicators like a STA or SRNA. The terminal may receive one or more indicators that is it allowed to use in the form of one or more of: (i) an “0” and/or “1” first indicators (which can also be considered as a first part of the indicator) and (ii) a list of any number of identifiers, e.g. STA or SRNA. As the skilled person, this structure of the information received from the terminal is applicable to cases where some or all of the indicator is determined by the core network and/or by the radion node.

In some cases, the method comprises determining that the first radio node is associated with at least one of a tracking area and RAN-based notification area; and communicating the least one of a tracking area and a RAN-based notification area to the radio node. In such cases, the response can further identify least one of a tracking area and RAN-based notification area as being allowed for the terminal. For example the least one of a tracking area and RAN-based notification area is associated with radio nodes having a movable position. The system may for example be configured to use one or more particular or reserved TA and/or RNA for movable radio nodes and a corresponding STA and/or SRNA of one, two or more STAs and/or SRNAs for the particular TA or RNA at hand.

In some cases where the telecommunications network comprising a second radio node configured to provide a wireless access interface to communicate with the terminal, the method may also further comprise determining that the second radio node has a movable position, determining a second indicator for the second radio node based on the determination that the second radio node has a movable position; determining that the second radio node is associated with the tracking area; identifying the second indicator to the second radio node; and communicating the tracking area to the second radio node. This is similar to the method steps in respect of first radio node. However in this case, the response to the terminal identifies that the second indicator is not allowed for the terminal. This can be either explicit (e.g. it is blacklisted) and/or implicit (e.g. it is not whitelisted).

In some examples there is provided a core network system which is configured to implement any of the methods discussed above in respect of FIG. 6, and it is expected that the management of areas and area updates can be optimised for cases where the network includes one or more movable radio nodes.

FIG. 7 illustrates an example method of operating a radio node in accordance with techniques discussed herein. The radio can be used in a telecommunications network, the telecommunications network comprising the radio node and a terminal wherein the radio node is configured to provide a wireless access interface to communicate with the terminal. The method comprises the radio node transmitting a first request to a core network system identifying that the radio node has a movable position. In response to the first request, the radio node receives a notification of a first indicator for assisting a terminal mobility procedure and transmits the first indicator to the terminal. When the first indicator is allowed for the terminal, the terminal can send to the radio node a request for the radio node to serve the terminal via the wireless access interface. The terminal may then be served by the radio node via the wireless access interface, for example if the terminal was allowed to access the radio node.

In some cases, the first indicator comprises one or more of a secondary tracking area; an indicator associated with a movable radio node position; a secondary RAN-based notification area and a one bit indicator identifying a movable radio node position.

In some examples, the radio node receives from the core network system, a tracking area associated with the radio node; and transmitting the tracking area to the terminal where, optionally, the tracking area is associated with radio nodes having a movable position. Accordingly, in some cases the radio node may transmit (e.g. broadcast) a tracking area for the radio node and a (separate or additional) indicator.

Additionally or alternatively, the radio node may determine a RAN-based notification area associated with the radio node; and transmit the RAN-based notification area to the terminal where, optionally, the RAN-based notification area is associated with radio nodes having a movable position. Accordingly, in some cases the radio node may transmit (e.g. broadcast) a RAN-based notification area for the radio node and a (separate or additional) indicator.

In some implementations, transmitting the first indicator to the terminal comprises broadcasting the first indicator.

In some cases, the radio node may broadcast system information for the radio node, where the system information comprises the first indicator.

As will be appreciated, the radio node may at least one of: a relay node, an IAB node, a UAV, a base station and a gNB.

In some examples there is provided a radio node which is configured to implement any of the methods discussed above in respect of FIG. 7, and it is expected that the management of areas and area updates can be optimised for cases where the network includes one or more movable radio nodes.

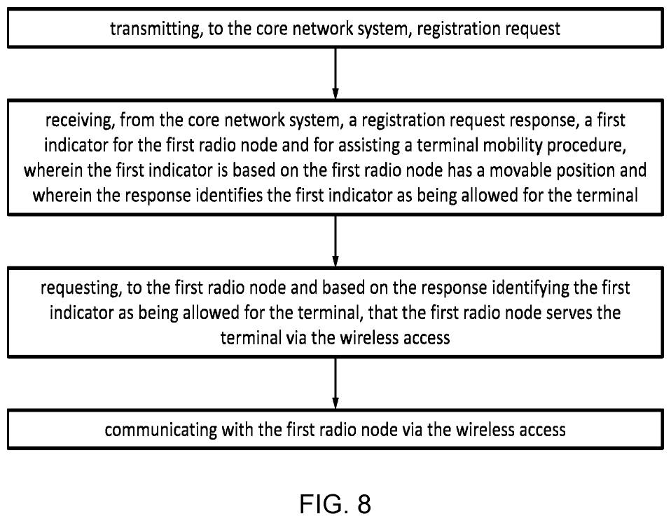

FIG. 8 illustrates an example method of operating a terminal in accordance with techniques discussed herein. The terminal can be used in a telecommunications network, the telecommunications network comprising a core network system, a first radio node and the terminal wherein the first radio node is configured to provide a wireless access interface to communicate with the terminal. The method comprises the terminal transmitting, to the core network system, registration request. The terminal can receive a registration request response identifying a first indicator for the first radio node and for assisting a terminal mobility procedure, where the first indicator is based on the first radio node having a movable position. The response identifies the first indicator as being allowed for the terminal. The registration request may be received from the core network system (e.g. in a system where the indicator is an STA and mirrors a core network-managed tracking area system) or from the first radio node (e.g. in a system where the indicator is an SRNA and mirrors a RAN-managed tracking area system). It will also be appreciated that both techniques may be combined and that both a core network-based indicator and a RAN-based indicator may be received. In accordance with the techniques discussed herein, the indicator allows the terminal to manage its mobility by informing the terminal's decision of whether to request to be served by a radio node.

For example, the indicator may be at least partially explicitly indicated in the response (e.g. comprised in the response) and/or may be at least partially implicitly indicated in the response (e.g. the terminal may derive the indicator from information included in the response). Whichever technique is used to identify the indicator to the terminal, the terminal is able to identify or derive the indicator and to identify the indicator as being allowed.

The terminal receives, from the first radio node, the first indicator and requests, to the first radio node and based on the response identifying the first indicator as being allowed for the terminal, that the first radio node serves the terminal via the wireless access. The terminal can then communicate with the first radio node via the wireless access, e.g. if the request to be served by the first radio node is successful.

In some cases, the response further identifies a tracking area as being allowed for the terminal and the terminal receives from the first radio node, the tracking area. Requesting that the first radio node serves the terminal can then further be based on the response identifying the tracking area as being allowed for the terminal. For example, the terminal receives both the tracking area and the indicator from the radio node as being associated with the radio node and can check whether it is allowed to access the radio node based on both the tracking area and the indicator having been identified as allowed. It will also be appreciated that the same technique may be used where the allowed or allowable tracking area or indicator may be transmitted in different responses or messages. In some examples, the tracking area is a TA associated with radio nodes having a movable position.

For example, the telecommunications network may comprise a second radio node configured to provide a wireless access interface to communicate with the terminal and the terminal may receive, from the core network system, a second indicator wherein the second indicator is for the second radio node and for assisting the terminal mobility procedure, wherein the second indicator is also based on the second radio node having a movable position and wherein the response to the terminal identifies the second indicator as not being allowed for the terminal. For example, it may be a message received from a core network system through the radio node, or from the radio node itself (e.g. if it is an indicator which mirrors a TA or RNA, respectively).

The terminal may also receive, from the second radio node, the second indicator and the tracking area, for example broadcasted with system information or otherwise communicated as being the indicator and the tracking area associated with the transmitting second radio node. The terminal can then determine, based on the response identifying the second indicator as not being allowed for the terminal, not to request to be served by the second radio node.

It will be appreciated that the teachings and techniques provided in respect of these example implementations where the terminal also receives a tracking area and uses the tracking area in combination with the indicator to determining whether it can be served by a radio node associated with the received TA can be applied equally to example implementation where (additionally or alternatively), the terminal receives a RAN-based notification area and uses the RNA in combination with the indicator to determining whether it can be served by a radio node associated with the received RNA.

In some examples, the first indicator may comprise one or more of a secondary tracking area; a secondary RAN-based notification area; an indicator associated with a movable radio node position; and a one bit indicator identifying a movable radio node position.

Additionally or alternatively, the terminal receiving the first indicator from the first radio node may comprise the terminal receiving the first indicator in a broadcast transmission of the first radio node, for example in a case the first indicator is transmitted as part of a system information broadcast transmitted by the first radio node.

It will also be appreciated that the teachings and techniques discussed above in respect of any of FIGS. 6, 7 and 8 apply equally to the methods and arrangements discussed in respect any other one of FIGS. 6, 7 and 8 as these methods correspond to each other but in respect of different perspectives in the network.

As discussed above, an STA could be a portion or sub-division of a cell (e.g. one or more coverage areas within a cell) and/or may comprise at least a portion of each of a plurality of cells. For example, an STA could be either a combination of one or more vehicle-to-everything (V2X) zones with particular identifier(s), a range of GNSS locations, or an STA could be implemented by ranging signals and/or WLAN signals confined within an area (e.g. identifying indoor location) or a specific beam coverage area (as NR networks support directional beams within gNB coverage), and any other type of wireless coverage which is associated with a movable radio node.

While reference has sometimes been made to particular sets of standards, for example different release versions (“Release 17”, etc.), it will be appreciated that this is done for illustrative purposes only and the teachings and techniques of the present invention are not limited to these particular systems but rather these systems are used to illustrate which limitations that can be found in some systems and why.

Additionally, the method steps discussed in the present description may be carried out in any suitable order as long as it is technically feasible and the illustrated order is not prescriptive. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example, transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a terminal device or network node may be configured accordingly if appropriate, so long as it is technically feasible and not explicitly excluded.

Whenever the expressions “greater than” or “smaller than” or equivalent are used herein, it is intended that they disclose both alternatives “and equal to” and “and not equal to” unless one alternative is expressly excluded.

It will be appreciated that while the present disclosure has in some respects focused on implementations in a 4G or 5G network as such a network is expected to provide the primary use case at present, the same teachings and principles can also be applied to other wireless telecommunications systems. Thus, even though the terminology used herein is generally the same or similar to that of the 4G or 5G standards, the teachings are not limited to the present versions of 4G or 5G and could apply equally to any appropriate arrangement not based on 4G or 5G, for example any arrangement possibly compliant with any future version of an LTE, 5G or other standards—defined by the 3GPP standardisation groups or by other groups. Accordingly, the teaching provided herein using 3GPP, 4G and/or 5G terminology can be equally applied to other systems with reference to the corresponding functions.

It is noteworthy that where a “predetermined” element is mentioned, it will be appreciated that this can in some cases include a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product or computer readable medium, comprising for example computer-readable instructions which can be executed by a computer, for carrying a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely illustrative examples of the present disclosure. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:

Clause 1. A method of operating a system in a telecommunications network, the telecommunications network comprising at least a first radio node and a terminal wherein the first radio node is configured to provide a wireless access interface to communicate with the terminal, the method comprising:
determining that the first radio node has a movable position;
determining a first indicator for the first radio node and for assisting a terminal mobility procedure, based on the determination that the first radio node has a movable position;
identifying the first indicator to the radio node;
receiving a registration request from the terminal;
communicating a response to the registration request to the terminal, wherein the response to the terminal identifies the first indicator as being allowed for the terminal.

Clause 2. The method of Clause 1 further comprising:
determining that the first radio node is associated with at least one of a tracking area and RAN-based notification area; and
communicating the least one of a tracking area and a RAN-based notification area to the radio node, wherein the response further identifies least one of a tracking area and RAN-based notification area as being allowed for the terminal.

Clause 3. The method of Clause 2 wherein the least one of a tracking area and RAN-based notification area is associated with radio nodes having a movable position.

Clause 4. The method of Clause 2 or 3, where the telecommunications network comprising a second radio node configured to provide a wireless access interface to communicate with the terminal, wherein the method further comprises:
determining that the second radio node has a movable position;
determining a second indicator for the second radio node based on the determination that the second radio node has a movable position;
determining that the second radio node is associated with the tracking area;
identifying the second indicator to the second radio node; and
communicating the tracking area to the second radio node, wherein the response to the terminal identifies the second indicator as not being allowed for the terminal.

Clause 5. The method of any preceding Clause wherein the first indicator comprises one or more of:
a secondary tracking area;
a secondary RAN-based notification area;
an indicator identifying a radio node having a movable position; and
a one bit indicator identifying a radio node having a movable position.

Clause 6. A core network system for use in a telecommunications network, the telecommunications network comprising at least a first radio node and a terminal wherein the first radio node is configured to provide a wireless access interface to communicate with the terminal, the core network system comprising a processor and memory for storing instructions, wherein the instructions, when performed by the processor, cause the system to:
determine that the first radio node has a movable position;
determine a first indicator for the first radio node and for assisting a terminal mobility procedure, based on the determination that the first radio node has a movable position;
identify the first indicator to the radio node;
receive a registration request from the terminal;
communicate a response to the registration request to the terminal, wherein the response to the terminal identifies the first indicator as being allowed for the terminal.

Clause 7. A core network system for use in a telecommunications network, the telecommunications network comprising at least a first radio node and a terminal wherein the first radio node is configured to provide a wireless access interface to communicate with the terminal, the core network system being configured to implement the method of any one of Clauses 1 to 5

Clause 8. A method of operating a radio node in a telecommunications network, the telecommunications network comprising the radio node and a terminal wherein the radio node is configured to provide a wireless access interface to communicate with the terminal, the method comprising:
transmitting a first request to a core network system identifying that the radio node has a movable position;
in response to the first request, receiving a notification of a first indicator for assisting a terminal mobility procedure; and
transmitting the first indicator to the terminal;
when the first indicator is allowed for the terminal, receiving from the terminal a request to serve the terminal via the wireless access interface, and serving the terminal via the wireless access interface.

Clause 9. The method of Clause 8 wherein the first indicator comprises one or more of:
a secondary tracking area;
a secondary RAN-based notification area;
an indicator associated with a movable radio node position; and
a one bit indicator identifying a movable radio node position.

Clause 10. The method of Clause 8 or 9 further comprising:
receiving from the core network system, a tracking area associated with the radio node; and
transmitting the tracking area to the terminal.

Clause 11. The method of Clause 10 wherein the tracking area is associated with radio nodes having a movable position.

Clause 12. The method of any one of Clauses 8 to 11 further comprising:
determining a RAN-based notification area associated with the radio node; and
transmitting the RAN-based notification area to the terminal.

Clause 13. The method of Clause 12 wherein the RAN-based notification area is associated with radio nodes having a movable position.

Clause 14. The method of any of Clauses 8 to 13 wherein transmitting the first indicator to the terminal comprises broadcasting the first indicator.

Clause 15. The method of any of Clauses 8 to 14 further comprising broadcasting system information for the radio node, the system information comprising the first indicator.

Clause 16. The method of any of Clauses 8 to 15 wherein the radio node is at least one of: a relay node, an IAB node, a UAV, a base station and a gNB.

Clause 17. A radio node for use in a telecommunications network, the telecommunications network comprising the radio node and a terminal wherein the radio node is configured to provide a wireless access interface to communicate with the terminal, the radio node comprising a processor and memory for storing instructions, wherein the instructions, when performed by the processor, cause the radio node to:
transmit a first request to a core network system identifying that the radio node has a movable position;
receive, in response to the first request, a notification of a first indicator for assisting a terminal mobility procedure; and
transmit the first indicator to the terminal;
when the first indicator is allowed for the terminal,
receive from the terminal a request to serve the terminal via the wireless access interface, and serve the terminal via the wireless access interface.

Clause 18. A radio node for use in a telecommunications network, the telecommunications network comprising the radio node and a terminal wherein the radio node is configured to provide a wireless access interface to communicate with the terminal, wherein the radio node is configured to implement the method of any one of Clauses 8 to 16.

Clause 19. A method of operating a terminal in a telecommunications network, the telecommunications network comprising a core network system, a first radio node and the terminal wherein the first radio node is configured to provide a wireless access interface to communicate with the terminal, the method comprising:
transmitting, to the core network system, registration request;
receiving a registration request response identifying a first indicator for the first radio node and for assisting a terminal mobility procedure,
wherein the first indicator is based on the first radio node having a movable position and wherein the response identifies the first indicator as being allowed for the terminal;
receiving, from the first radio node, the first indicator;
requesting, to the first radio node and based on the response identifying the first indicator as being allowed for the terminal, that the first radio node serves the terminal via the wireless access;
communicating with the first radio node via the wireless access.

Clause 20. The method of Clause 19, wherein
the response further identifies a tracking area as being allowed for the terminal;
the method further comprises receiving from the first radio node, the tracking area; and
the requesting that the first radio node serves the terminal is further based on the response identifying the tracking area as being allowed for the terminal.

Clause 21. The method of Clause 20 wherein the tracking area is associated with radio nodes having a movable position.

Clause 22. The method of Clause 20 or 21, where the telecommunications network comprising a second radio node configured to provide a wireless access interface to communicate with the terminal, wherein the method further comprises:
receiving, from the second radio node, a second indicator wherein the second indicator is for the second radio node and for assisting the terminal mobility procedure,
wherein the second indicator is based on the second radio node having a movable position and
wherein the response to the terminal identifies the second indicator as not being allowed for the terminal.
receiving, from the second radio node, the second indicator and the tracking area; and
determining based on the response identifying the second indicator as not being allowed for the terminal, not to request to be served by the second radio node.

Clause 23. The method of any of Clauses 19 to 22 wherein the first indicator comprises one or more of:
a secondary tracking area;
a secondary RAN-based notification area;
an indicator associated with a movable radio node position; and
a one bit indicator identifying a movable radio node position.

Clause 24. The method of any of Clauses 19 to 23 wherein receiving from the first radio node, the first indicator comprises receiving the first indicator in a broadcast transmission of the first radio node.

Clause 25. The method of Clause 24, wherein the first indicator is transmitted as part of a system information broadcast transmitted by the first radio node.

Clause 26. A terminal for use in a telecommunications network, the telecommunications network comprising a core network system, a first radio node and the terminal wherein the first radio node is configured to provide a wireless access interface to communicate with the terminal, the terminal comprising a processor and memory for storing instructions, wherein the instructions, when performed by the processor, cause the terminal to:
transmit, to the core network system, registration request;
receive a registration request response identifying a first indicator for the first radio node and for assisting a terminal mobility procedure,
wherein the first indicator is based on the first radio node having a movable position and wherein the response identifies the first indicator as being allowed for the terminal;
receive, from the first radio node, the first indicator;
request, to the first radio node and based on the response identifying the first indicator as being allowed for the terminal, that the first radio node serves the terminal via the wireless access;
communicate with the first radio node via the wireless access.

Clause 27. A terminal for use in a telecommunications network, the telecommunications network comprising a core network system, a first radio node and the terminal wherein the first radio node is configured to provide a wireless access interface to communicate with the terminal, the terminal being configured to implement the method of any one of Clauses 19 to 25.

Clause 28. Circuitry for a core network system for use in a telecommunications network, the telecommunications network comprising at least a first radio node and a terminal wherein the first radio node is configured to provide a wireless access interface to communicate with the terminal, the circuitry comprising receiver circuitry, transmitter circuitry and controller circuitry configured to control the transmitter circuitry and the receiver circuitry to transmit data or receive data, wherein the controller circuitry is configured with the receiver circuitry and transmitter circuitry to:
determine that the first radio node has a movable position;
determine a first indicator for the first radio node and for assisting a terminal mobility procedure, based on the determination that the first radio node has a movable position;
identify the first indicator to the radio node;
receive a registration request from the terminal;
communicate a response to the registration request to the terminal, wherein the response to the terminal identifies the first indicator as being allowed for the terminal.

Clause 29. Circuitry for a radio node for use in a telecommunications network, the telecommunications network comprising the radio node and a terminal wherein the radio node is configured to provide a wireless access interface to communicate with the terminal, the circuitry comprising receiver circuitry, transmitter circuitry and controller circuitry configured to control the transmitter circuitry and the receiver circuitry to provide the wireless interface and to communicate with a core network system of the network and to:
transmit a first request to a core network system identifying that the radio node has a movable position;
receive, in response to the first request, a notification of a first indicator for assisting a terminal mobility procedure; and
transmit the first indicator to the terminal;
when the first indicator is allowed for the terminal,
receive from the terminal a request to serve the terminal via the wireless access interface, and serve the terminal via the wireless access interface.

Clause 30. Circuitry for a terminal for use in a telecommunications network, the telecommunications network comprising a core network system, a first radio node and the terminal wherein the first radio node is configured to provide a wireless access interface to communicate with the terminal, the circuitry comprising receiver circuitry, transmitter circuitry and controller circuitry configured to control the transmitter circuitry and the receiver circuitry to communicate with the first radio node via the wireless access interface and to:
transmit, to the core network system, registration request;
receive a registration request response identifying a first indicator for the first radio node and for assisting a terminal mobility procedure, wherein the first indicator is based on the first radio node having a movable position and wherein the response identifies the first indicator as being allowed for the terminal;
receive, from the first radio node, the first indicator;
request, to the first radio node and based on the response identifying the first indicator as being allowed for the terminal, that the first radio node serves the terminal via the wireless access;
communicate with the first radio node via the wireless access.

### REFERENCES

[1] Holma H. and Toskala A, “LTE for UMTS OFDMA and SC-FDMA based radio access”, John Wiley and Sons, 2009.
[2] TS 23.316 “Wireless and wireline convergence access support for the 5G System (5GS)”, Release 17, V17.1.0, 2021-09
[3] S2-2108855 “DP on new objective for FS_eEDGE_5GC_ph2: potential solutions for the AF to be able to obtain/determine the DNAI in Release 18”, 2021-11 (3GPP TSG-SA WG2 Meeting #148e)
[4] TS 23.501 “System architecture for the 5G System (5GS); Stage 2”, V17.2.0, 2021-09
[5] TS 24.193 “Access Traffic Steering, Switching and Splitting (ATSSS); Stage 3”, Release 17, V17.2.0, 2021-09

1. A method of operating a system in a telecommunications network, the telecommunications network comprising at least a first radio node and a terminal wherein the first radio node is configured to provide a wireless access interface to communicate with the terminal, the method comprising:
determining that the first radio node has a movable position;
determining a first indicator for the first radio node and for assisting a terminal mobility procedure, based on the determination that the first radio node has a movable position;
identifying the first indicator to the radio node;
receiving a registration request from the terminal;
communicating a response to the registration request to the terminal, wherein the response to the terminal identifies the first indicator as being allowed for the terminal.

2. The method of claim 1 further comprising:
determining that the first radio node is associated with at least one of a tracking area and RAN-based notification area; and
communicating the least one of a tracking area and a RAN-based notification area to the radio node,
wherein the response further identifies least one of a tracking area and RAN-based notification area as being allowed for the terminal.

3. The method of claim 2 wherein the least one of a tracking area and RAN-based notification area is associated with radio nodes having a movable position.

4. The method of claim 2, where the telecommunications network comprising a second radio node configured to provide a wireless access interface to communicate with the terminal, wherein the method further comprises:
determining that the second radio node has a movable position;
determining a second indicator for the second radio node based on the determination that the second radio node has a movable position;
determining that the second radio node is associated with the tracking area;
identifying the second indicator to the second radio node; and
communicating the tracking area to the second radio node,
wherein the response to the terminal identifies the second indicator as not being allowed for the terminal.

5. The method of claim 1 wherein the first indicator comprises one or more of:
a secondary tracking area;
a secondary RAN-based notification area;
an indicator identifying a radio node having a movable position; and
a one bit indicator identifying a radio node having a movable position.

6. A core network system for use in a telecommunications network, the telecommunications network comprising at least a first radio node and a terminal wherein the first radio node is configured to provide a wireless access interface to communicate with the terminal, the core network system comprising a processor and memory for storing instructions, wherein the instructions, when performed by the processor, cause the system to:
determine that the first radio node has a movable position;
determine a first indicator for the first radio node and for assisting a terminal mobility procedure, based on the determination that the first radio node has a movable position;
identify the first indicator to the radio node;
receive a registration request from the terminal;
communicate a response to the registration request to the terminal, wherein the response to the terminal identifies the first indicator as being allowed for the terminal.

7. A method of operating a radio node in a telecommunications network, the telecommunications network comprising the radio node and a terminal wherein the radio node is configured to provide a wireless access interface to communicate with the terminal,
the method comprising:
transmitting a first request to a core network system identifying that the radio node has a movable position;
in response to the first request, receiving a notification of a first indicator for assisting a terminal mobility procedure; and
transmitting the first indicator to the terminal;
when the first indicator is allowed for the terminal,
receiving from the terminal a request to serve the terminal via the wireless access interface, and
serving the terminal via the wireless access interface.

8. The method of claim 7 further comprising:
receiving from the core network system, a tracking area associated with the radio node; and
transmitting the tracking area to the terminal.

9. The method of claim 8 wherein the tracking area is associated with radio nodes having a movable position.

10. The method of claim 7 further comprising:
determining a RAN-based notification area associated with the radio node; and
transmitting the RAN-based notification area to the terminal.

11. The method of claim 10 wherein the RAN-based notification area is associated with radio nodes having a movable position.

12. The method of claim 7 wherein transmitting the first indicator to the terminal comprises broadcasting the first indicator.

13. The method of claim 7 further comprising broadcasting system information, the system information comprising the first indicator.

14. The method of claim 7 wherein the radio node is at least one of: a relay node, an IAB node, a UAV, a base station and a gNB.

15-24. (canceled)
